(19) United States
(12) Patent Application Publication
(10) Pub. No.: US 2008/0151992 A1
(43) Pub. Date: Jun. 26, 2008

(54) Method for dynamically adjusting video frame

(76) Inventor: Shih-Fang Chuang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/717,035

(22) Filed: Mar. 13, 2007

(30) Foreign Application Priority Data
Dec. 25, 2006 (TW) 95148690

(51) Int. Cl. H04N 11/02

(52) U.S. Cl. 375/240.01

(57) ABSTRACT

A method for dynamically adjusting video frame is adapted to store video data to a cache memory with a plurality of registers. The method comprises the steps: first, receiving the video data and compressing the video frames; next, obtaining a first usage level of the cache memory; next, gathering statistics regarding the amount of registers that have been set at an indicating status in the circular queue; next, calculating a second usage level of the cache memory according to the amount of the indicating status; next, adjusting the size of the video frames by comparing the difference between the second usage level and the first usage level; and finally, storing the video data to the cache memory according to the size of the video frames. Thereby, all of the space of the cache memory is used fully to extend video recording time.

### BACKGROUND OF THE INVENTION

1. Field of the invention

The invention relates to a method for adjusting video frames, and more particularly to a method for dynamically adjusting video frames while video data is being recorded.

2. Description of the Prior Art

Recently, with the rapid development of the digital age, digital video cameras, digital cameras, and other digital video recording devices have become more common devices for consumers to own. Presently, most digital video recording devices are matched with various memories for storing media files. Meanwhile, companies in the field have constantly been developing highly effective, large-capacity memories to satisfy user demand.

Please refer to FIG. 1, which is a schematic diagram of a method for recording video according to the prior art. The recording method comprises: a video recording unit 1a receives video data 2a that the user wishes to record, and the video data 2a is stored into a cache memory 10a. Next, the video data 2a stored in the cache memory 10a is written to the memory card 3a which is externally connected according to the writing velocity of the memory card 3a. However, due to the different writing velocities of the various memory cards 3a and the writing velocity is usually less than the writing velocity for storing video data 2a to the cache memory 10a. Because the transmission unit of the video data 2a is a fixed frame size, the remaining space of the cache memory 10a may be less than the size of the video frame of the video data 2a thereby causing the recording to be stopped.

The inventor of the present invention recognizes the above shortage should be improved and special effort has been made to research this field. The present invention is presented with reasonable design to resolve the above problems.

### SUMMARY OF THE INVENTION

The primary object of the present invention is to provide a method for dynamically adjusting video frames using a cache memory designed as a circular queue to be a storage media for reading or writing video data. In addition, the used level and condition of the circular queue is determined to momentarily adjust the size of the video frames during a process of recording video data so that the space of the cache memory can be used efficiently and recording time can be extended.

To achieve the object stated above, a method for dynamically adjusting video frames is adapted to store video data to a cache memory with a plurality of registers, comprising the steps: first, receiving the video data and compressing the video frames; next, obtaining a first usage level of the cache memory; next, gathering statistics regarding the amount of registers that have been set at an indicating status in the circular queue; next, calculating a second usage level of the cache memory according to the amount of the indicating status; next, adjusting the size of the video frames by comparing the difference between the second usage level and the first usage level; and finally, storing the video data to the cache memory according to the size of the video frames.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is a schematic diagram of recording video according to the prior art;

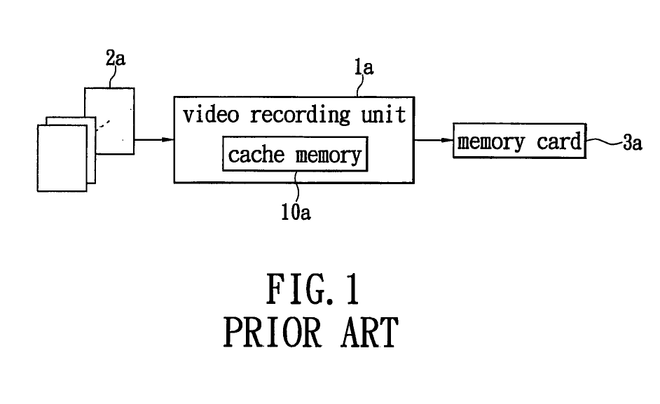

FIG. 2 is a schematic view of an applied embodiment of a cache memory using a circular queue according to the present invention; and

FIG. 3 is a flowchart of an embodiment of a method for dynamically adjusting video frames according to the present invention.

The drawings will be described further in connection with the following detailed description of the present invention.

### DETAILED DESCRIPTION OF THE PREFERRED EMBODIMENTS

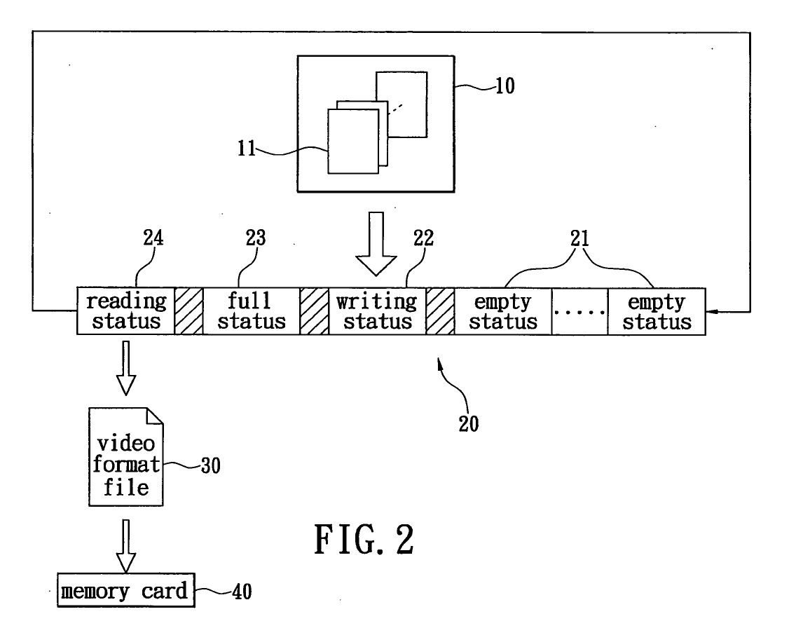

Please refer to FIG. 2, which is a schematic view of an applied embodiment of a cache memory using a circular queue according to the present invention. A method for dynamically adjusting video frame 11 is adapted to store video data 10 to a cache memory with a plurality of registers. The cache memory is designed as a circular queue 20. The video data is composed of at least one video frame 11, and further video data 10 is stored in the circular queue 20 in a basic unit of a video frame 11 and each of the registers has a uniform property.

The registers can be set at an empty status 21, a writing status 22, a full status 23, or a reading status 24. Empty status 21 means that the registers don't have any data stored therein. When the video data 10 is ready to be stored in the circular queue 20, the empty status 21 of the registers has to be changed to writing status 22 so that the video data 10 can be stored according to the video frames 11. When the registers are full, the writing status 22 is changed to full status 23. Next, when the video data 10 is further constructed as a video format file 30, the full status 23 of the registers has to be changed to the reading status 24 so as to read the data. Next, the video format file 30 is stored to a memory card 40. The video format file 30 can be an M-JPEG (motion joint photographic experts group). In addition, when the video data 10 of the registers have constructed as the video format file 30, the registers erase the space thereof and the full status 23 of the registers is changed to empty status 21. Hence, the different statuses are repeatedly set to complete the operation of the circular queue 20.

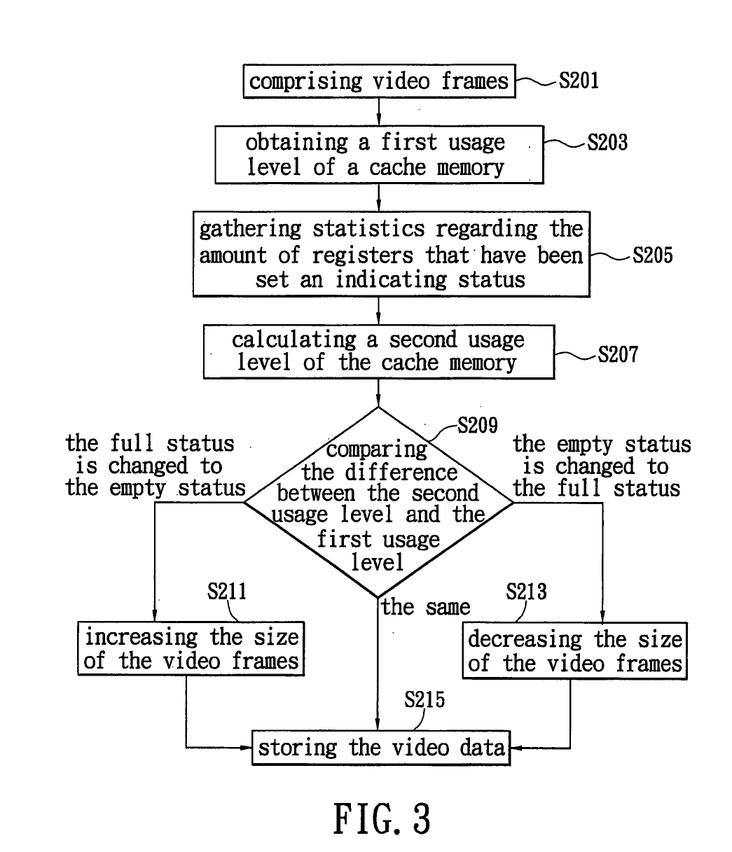

Please refer to FIG. 3, which is a flowchart of an embodiment of a method for dynamically adjusting video frames according to the present invention. The method for dynamically adjusting the size of the video frame 11 is adapted to store video data 10 to the cache memory when the memory card 40 reads the cache memory, and comprises the following steps: first, receiving the video data 10 and comprising the video frames 11 (S201); next, obtaining a first usage level of the cache memory desired as a circular queue 20 (S203); next, gathering statistics regarding the amount of the registers that have been set as an indicating status in the circular queue 20 (S205), and the indicating status of the registers can be a full status 23 or an empty status 21; next, calculating a second usage level of the cache memory according to the amount of the indicating status (S207), and the first usage level and the second usage level are usage level of the circular queue 20 of the cache memory, also percentage of the used registers and the unused registers of the cache memory. Furthermore, taking as an example to explain the above-mentioned description, the first usage level and the second usage level can be defied as 0(Empty), ¼(Almost Empty), 2/4(Half Full), ¾(Almost Full), or 1(Full) according to the usage percentage of the circular queue 20.

Next, comparing the difference between the second usage level and the first usage level of the cache memory of the circular queue 20 (S209). The cache memory of the circular queue 20 is accessed and operated in a multitasking manner, i.e. the circular queue 20 not only writes the storage of the video frames 11 but also simultaneously reads the data to be stored to the memory card 40. If an access speed of the memory cards 40 is slow, the video data 10 is continuously stored in the circular queue 20 so that the second usage level is greater than the first usage level. Oppositely, if the access speed of the memory card 40 is fast, the video data 10 can be stored to the memory card 40 faster, and the full status 23 of the registers can be changed to empty status 21 so that the second usage level is less than the first usage level.

If the comparison result in the step (S209) is that the second usage level is less than the first usage level—the amount of the full status 23 being changed to the empty status 21 is increased, that meaning the access speed of the memory card 40 is fast, the size of the video frames can be increased (S211) to provide a better quality of video. On the other hand, if the comparison result in the step (S209) is that the second usage level is greater than the first usage level—the amount of the empty status 21 being changed to the full status 21 is increased, that meaning the access speed of the memory card 40 is slow, the cache memory of the circular queue 20 is not enough easily, and causes to stop recording. Hence, the size of the video frame 11 is decreased to reduce the usage level of circular queue 20 to extend video recording time. Further, if the comparison result in the step (S209) is that the second usage level is equal to the first usage level or the step (S211) or the step (S213) has finished, the video data 10 is stored to the circular queue 20 according to the size of the video frames 11 (S215).

In addition, the size of the video frames 11 can be gradually adjusted by adjusting the percentage thereof. However, the size of the video frames 11 is not adjusted to fixed size at one time so as to prevent influencing the quality of the video.

If follows from what has been said that the present invention manages the usage levels of the cache memory due to the access speeds of different memory card 40 to adjust the size of the video frames 11 of the video data 10 so as to completely use the space of the cache memory to extend the time for recording video, and preventing huge variations in the available recording time due to the use of memory cards 40 with different access speeds produced by different companies.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for dynamically adjusting video frames in which the size of video frames are dynamically adjusted and then stored to a cache memory when the cache memory is read by a memory card, comprising the steps:
determining a using status of the cache memory, wherein the cache memory is composed of a plurality of registers;
decreasing the size of the video frames to be stored to the cache memory when the using status of the cache memory is that the amount of the empty status being changed to the full status is increased; and
increasing the size of the video frames to be stored to the cache memory when the using status of the cache memory is that the amount of the full status being changed to the empty status is increased.

2. The method for dynamically adjusting video frames as claimed in claim 1, wherein the cache memory operates in a multitasking manner to simultaneously write and read the data of the cache memory.

3. The method for dynamically adjusting video frames as claimed in claim 1, wherein the statuses of the registers can be separately set as a writing status or a reading status.

4. The method for dynamically adjusting video frames as claimed in claim 1, wherein the status of the registers is set at the empty status after the data of the registers have been stored in the memory card.

5. The method for dynamically adjusting video frames as claimed in claim 1, wherein the size of the video frames is gradually adjusted by adjusting the percentage thereof.

6. A method for dynamically adjusting video frames in which the size of video frames are dynamically adjusted and then stored to a cache memory when the cache memory is read by a memory card, comprising the steps:
receiving and compressing the video frames, wherein the video frames are used to compose a video data;
obtaining a first usage level of the cache memory, wherein the cache memory is composed of a plurality of registers;
gathering statistics regarding the amount of registers that have been set at an indicating status in the circular queue;
calculating a second usage level of the cache memory according to the amount of the indicating status;
adjusting the size of the video frames by comparing the difference between the second usage level and the first usage level; and
storing the video data to the cache memory according to the size of the video frames.

7. The method for dynamically adjusting video frames as claimed in claim 6, wherein the video data is composed of the video frames, and the video frames are storage units.

8. The method for dynamically adjusting video frames as claimed in claim 6, wherein the cache memory operates in a multitasking manner to simultaneously write and read the data of the cache memory.

9. The method for dynamically adjusting video frames as claimed in claim 6, wherein the cache memory is designed as a circular queue.

10. The method for dynamically adjusting video frames as claimed in claim 6, wherein the registers are formed a uniform property.

11. The method for dynamically adjusting video frames as claimed in claim 6, wherein the indicating status of the registers can be set at a full status or an empty status.

12. The method for dynamically adjusting video frames as claimed in claim 11, wherein the status of the registers can be separately set at a writing status or a reading status.

13. The method for dynamically adjusting video frames as claimed in claim 12, wherein the status of the registers is changed from empty status to writing status so that the video data can be stored.

14. The method for dynamically adjusting video frames as claimed in claim 11, wherein the status of the registers is changed from full status to reading status so that the video data can be further constructed to a video format file and then stored to the memory card.

15. The method for dynamically adjusting video frames as claimed in claim 14, wherein the status of the registers is erased and changed from reading status to empty status if the video data has been constructed to the video format file.

16. The method for dynamically adjusting video frames as claimed in claim 14, wherein the video format file is an M-JPEG (motion joint photographic experts group).

17. The method for dynamically adjusting video frames as claimed in claim 6, wherein the first usage level and the second usage level are percentage levels of the used registers and the unused registers of the cache memory.

18. The method for dynamically adjusting video frames as claimed in claim 17, wherein the first usage level and the second usage level can be defined as 0(Empty), ¼(Almost Empty), 2/4(Half Full), ¾(Almost Full), or 1(Full) according to the usage percentage.

19. The method for dynamically adjusting video frames as claimed in claim 6, wherein the size of the video frames is gradually adjusted by adjusting the percentage thereof.

20. The method for dynamically adjusting video frames as claimed in claim 6, wherein the size of the video frames is decreased if the second usage level is greater than the first usage level, and the size of the video frames is increased if the second usage level is less than the first usage level.
